(19) United States
(12) Patent Application Publication
(10) Pub. No.: US 2017/0006853 A1
(43) Pub. Date: Jan. 12, 2017

(54) DEVICE AND METHOD FOR TERMINATING A PLANT

(71) Applicant: Kismet R. Collins, New Orleans, LA (US)

(72) Inventor: Kismet R. Collins, New Orleans, LA (US)

(21) Appl. No.: 15/204,953

(22) Filed: Jul. 7, 2016

Related U.S. Application Data
(60) Provisional application No. 62/190,198, filed on Jul. 8, 2015.

(51) Int. Cl. A01M 21/04

(52) U.S. Cl. CPC A01M 21/043

(57) ABSTRACT

A plant attachment device is provided for applying an herbicide to a plant at an open plant wound, and thereby prevent unwanted plant growth. The device includes an elastic, generally tubular body with two opposing ends, one of which is left open for application over a cut plant stem or trunk, and the other which is closed to encapsulate the plant stem or trunk when the device is applied over the plant. The device includes an herbicide within the hollow chamber between the open end and the closed end. The device is made of an elastic material which is impenetrable and non-reactive when exposed to herbicide and water, thereby ensuring the herbicide remains enclosed within the device and in continuous contact the plant member so the plant member will absorb the herbicide and die.

The inventor, through this non-provisional patent application, claims priority based on prior provisional patent application No. 62/190,198.

### BACKGROUND OF THE INVENTION

This invention is directed to a device which applies one or more chemical treatments, such as herbicides, to a plant stem or trunk to terminate the plant after it has been cut or pruned. The state of the art for termination or prevention of unwanted plant regrowth includes various concepts and methods. The simplest methods are purely mechanical and involve either re-pruning the plant or removing the plant by its roots. However, regrowth of plants after cutting is very common and requires constant pruning which may be expensive and time-consuming. Many plants sprout multiple new branches and stems after they have been pruned, which increases the plant's invasive diameter and multiplies the gardener's re-pruning efforts. Constant re-pruning may also harm desirable surrounding plants. The application of chemicals to cut plants was born from the desire to eliminate regrowth.

Pulling the unwanted plant out by its roots also has significant drawbacks. This method is physically demanding, time-consuming, and may injure the human musculoskeletal system. The user may be allergic to the plant and suffer physical injury due to contact or even breathing the air near the plant. Such an example includes poison ivy. Pulling a plant out by its roots may disturb surrounding plant growth and damage nearby structures, including sidewalks, streets, retaining walls and buildings. Moreover, one is not assured to remove all of the plant's roots, which often results in unwanted plant regrowth. The gardener is faced with the same drawbacks when digging up the plant's root system, which may be expensive and more physically demanding than pulling up the plant.

An additional method for terminating unwanted plant regrowth includes spraying herbicides onto the plant. However, overspray due to wind or inaccurate spraying is common and may cause unintended application to surrounding plants, which might harm or kill them. Such overspray may also subject the user to harmful inhalation of the herbicide. Natural precipitation such as rain or snow may also dilute or wash the herbicide off which requires expensive, time-consuming re-application. Moreover, these problems result in soil and groundwater contamination which may harm the environment, humans and wildlife.

Paint and gel forms of concentrated herbicide may also be applied to the plant wound. However, this method is time-consuming and exposes the user to physical contact with the concentration, which may injure the user. Moreover, herbicides applied in these forms may easily wash off when it rains or when nearby vegetation is irrigated. Again, environmental damage may result from herbicide runoff. Finally, these forms of herbicide are typically sold in large quantities, which may significantly inconvenience the user who needs a small number of targeted herbicide applications.

An additional method of a targeted herbicide application includes injecting liquid herbicide into the plant wound. This method requires drilling and injection tools which are expensive and uncommon. With the proposed method, the user can apply the herbicide and rest assured it will remain in contact with the plant until sufficiently absorbed.

One may place a bag over the entire plant and then spray the plant with herbicide as in Abernathy U.S. Pat. No. 4,223,477. However, such a method and device is cumbersome, time-consuming, and requires constant user-operation. It also exposes the user to potential contact with the herbicide. Abernathy also does not ensure the herbicide will remain in continuous contact with the plant.

Another effort to target herbicidal treatment may be seen in King U.S. Pat. No. 6,233,866, which discloses a rigid cup-shaped housing with pie-shaped flaps intended to grip the plant stem and reduce environmental contamination. However, plant stems and trunks vary significantly in size and shape. Application of the King device is limited based on the size of the rigid cup compared with the size of the plant stem or trunk. Moreover, the pie-shaped flaps which surround the cut stem or trunk cannot create a seal around the stem or trunk. In contrast, the present invention adapts to multiple plant shapes and sizes while sealing the herbicide within the applicator.

Another targeted plant treatment which attempts to contain herbicide is seen in Boegli U.S. pat. application Ser. No. 11/107,007, which discloses use of two opposing substrates which contain herbicide and may be wrapped around a plant and attached via adhesive. However, the herbicide reservoir is designed to break upon contact with a plant. Such a delicate reservoir could easily rupture before it contacts the plant. In contrast, the present invention employs an elastic carrier means which will not easily break. Moreover, extreme outdoor conditions such as temperature, humidity and precipitation may break down the Boegli adhesive which may cause environmental contamination. The present invention employs a mechanical elastic means of attachment, which is simple and far more reliable than an adhesive attachment means.

The present invention provides a targeted herbicide applicator which is sufficiently flexible to be applied to a broad range of plant shapes and sizes. It ensures a tight seal around the plant stem or trunk, which will prevent wash-off and related environmental harm or over-application. User-exposure to the herbicide will be minimized compared with the prior art, as the device may come pre-loaded with the herbicide. The user will not be exposed to inhalation of the herbicide because the present invention does not include a spray application. The user will also be spared the cumbersome application of a loose shroud around the plant.

The present invention is useful for eliminating perennial plants and weeds by ensuring sufficient herbicide exposure to reach the plant roots while minimizing potentially harmful human and environmental exposure to herbicide.

### BRIEF SUMMARY OF THE INVENTION

The present invention comprises a generally tubular elastic device which carries herbicide and attaches to a pruned plant stem or trunk to ensure thorough and continuous application of herbicide to the plant while maintaining a virtually impenetrable physical barrier between the encapsulated portion of the plant and the exterior environment. The elastic device has one open end for insertion of the pruned plant stem or trunk. The end of the device opposite the open end is closed and contains the herbicide.

The open end of the device contains a constrictive, elastic band which encloses around the pruned plant stem or trunk and forms a mechanical seal around the plant. The seal created by the elastic band prevents unintended leakage of the herbicide into the environment or onto the user. The body of the device is likewise elastic to allow the device to be applied to a variety of shapes and sizes of cut plants, while maintaining sufficient structural integrity to withstand being pierced or torn during normal use.

Various other features, advantages and characteristics will become apparent after reading the following specification.

### BRIEF DESCRIPTION OF THE DRAWINGS

The preferred embodiments of the present invention are set forth in the figures, like items bearing like reference numerals and in which:

FIG. 1 shows an isometric drawing of the herbicide applicator containing the herbicide chemical;

FIG. 2 is a cross-sectional view of the herbicide applicator attached to a pruned plant stem or trunk.

### DETAILED DESCRIPTION AND BEST MODE OF IMPLEMENTATION

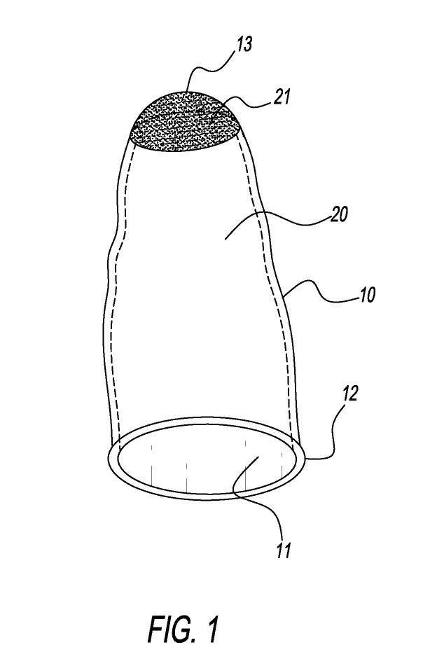

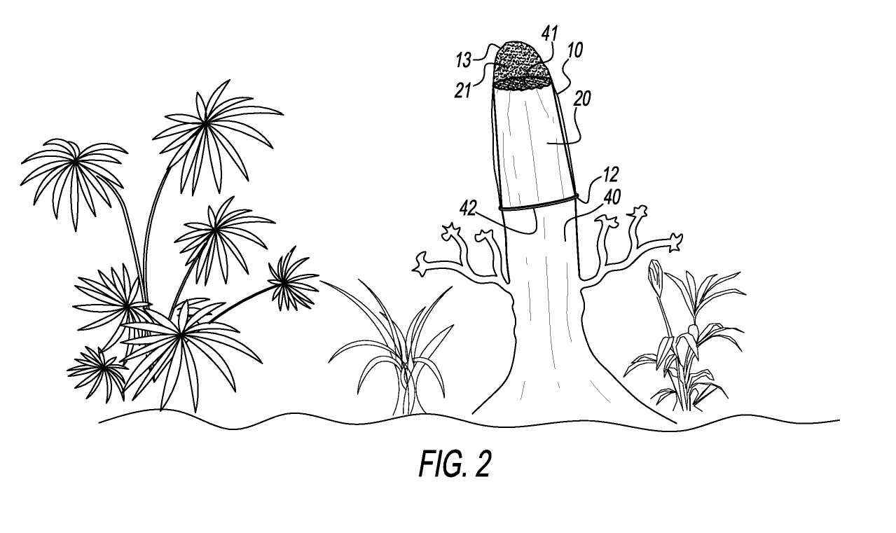

A preferred embodiment of the applicator is shown in FIGS. 1-2, generally at 10. FIG. 1 shows applicator 10 comprising a flexible or elastic tubular body with open end 11, closed end 13, and hollow chamber 20. Applicator 10 is further comprised of a flexible or elastic band 12 located around the circumference of open end 11, which engages the plant stem or trunk vis-à-vis radial stress created when flexible or elastic band 12 is stretched beyond its resting diameter. Elastic band 12 may have a smaller diameter than the cross-sectional diameter of applicator 10.

FIG. 2 shows a cross-sectional view of applicator 10 attached to pruned plant 40. Applicator 10 contains herbicide 21, designed and applied to plants for the purpose of killing them. Pruned plant 40 depicts a live plant which was pruned at exposed plant wound 41. The intended user of applicator 10 desires to apply herbicide 21 to plant 40 at plant wound 41 to kill plant 40.

Applicator 10 is preferably comprised of an elastomer with a low Young's modulus and high failure strain such that it may be stretched over a variety of plant shapes and sizes. It is preferred that the elastomer prevent transgression of the herbicide 20 to the exterior environment and, likewise, transgression of exterior matter into chamber 20. The elastomer preferably does not react with herbicide 21 and is impenetrable to herbicide 21 to ensure constant containment of herbicide 21 within chamber 20. Applicator 10 is also preferably comprised of an elastomer which resists water such that natural precipitation and irrigation fluids do not penetrate applicator 10 and dilute or wash herbicide 21 away. It is preferred that flexible or elastic band 12 forms a seal around plant 40 via radial stress exerted on plant 40 at attachment location 42 due to the size and elasticity of band 12. The intent is that plant 40 will absorb the herbicide 21 through plant wound 41 due to constant, undisturbed exposure to the herbicide 21.

In one embodiment, applicator 10 is comprised of a biodegradable elastomer which will decompose after plant 40 dies and applicator 10 falls to the ground. An example of such biodegradable material includes natural rubber or latex. In another embodiment, applicator 10 is comprised of a synthetic elastomer which withstands a variety of herbicides and natural elements for extended periods of time.

In a preferred embodiment, the herbicide 21 is in a gelatinous or highly viscous state to ensure it remains within chamber 20 when applicator 10 is exposed prior to application onto plant 40. This will help prevent inadvertent leakage of herbicide 21 into the environment or onto the user.

In one mode of operation, the intended user first prunes plant 40 such that plant wound 41 is exposed. Plant 40 is a type of invasive or undesirable plant which may require repeated open-air applications of an herbicide before it dies. Plant 40 may also be surrounded by more desirable plants and wildlife which accidental herbicide overspray may kill. In addition, plant 40 may include plants which are poisonous or harmful to the user if the user touches plant 40 or even breathes air which has passed over plant 40, such as poison ivy, poison oak or poison sumac.

After pruning plant 40, the user then accesses applicator 10 which is pre-filled with herbicide 21 inside hollow chamber 20. The user holds applicator 10 such that open end 11 is directly over plant wound 41 and applicator 10 shares the same longitudinal axis with plant 40. The user then stretches flexible or elastic band 12 located around the circumference of open end 11 so that flexible or elastic band 12 fits over and around the circumference of plant 40 at plant wound 41. The user then slides, stretches and/or rolls applicator 10 along the longitudinal axis of plant 40 until plant wound 41 touches the inside of closed end 13 and remains within hollow chamber 20. As a result, applicator 10 fully encapsulates plant 40 as shown in FIG. 2, such that plant wound 41 contacts herbicide 21.

The result is an enclosed application of herbicide 21 to plant 40 without exposure of herbicide 21 to the user, the environment or wildlife. Flexible or elastic band 12 forms a tight seal around plant 40 via radial stress such that herbicide 21 will not leak out of chamber 20, but will remain in constant contact with plant 40, particularly at plant wound 41, to ensure plant 40 is continuously exposed to herbicide 21 until it dies. In addition, the seal formed by flexible or elastic band 12 around plant 40 will prevent leakage of herbicide 21 into the environment, onto the user, and onto other wildlife, thereby preventing harm to the same. The herbicide-resistant properties of applicator 10 will help ensure herbicide 21 remains inside chamber 20 and in constant contact with plant 40 at plant wound 41. Natural precipitation and irrigation will not wash herbicide 21 off of plant 40 or plant wound 41 given the water-resistant properties of applicator 10.

Various changes, alternatives and modifications will become apparent after a reading of the foregoing specification. It is intended that all such changes, alternatives and modifications which fall within the scope of the appended claims be considered part of the invention.

I claim:

1. An herbicide application device to be stretched over a plant (40) for targeted application of a chemical treatment to plant (40), comprising:
an applicator (10) having a first open end (11), a second closed end (13), and a hollow chamber (20), said applicator being generally tubular when extended, comprised of an elastic material, and sized such that it may be stretched over a cut plant stem and generally conforms to the size and shape of said cut plant stem when stretched over said cut plant stem;
an herbicide (21) located inside chamber (20) and generally at said second closed end (13);
an elastic band (12), which forms a mechanical seal around said plant (40) when said applicator (10) is stretched over said plant (40) to maintain the applicator (10) in place on plant (40) and to seal the herbicide (21) inside chamber (20);

2. The herbicide application device of claim 1 wherein chamber (20) is pre-loaded with the herbicide (21);

3. The herbicide application device of claim 1 wherein the herbicide (21) is in a highly-viscous or gelatinous state;

4. The herbicide application device of claim 2 wherein the herbicide (21) is in a highly-viscous or gelatinous state;

5. The herbicide application device of claim 1 wherein said applicator (10) and elastic band (12) are comprised of a natural, non-synthetic elastomer;

6. The herbicide application device of claim 1 wherein said applicator (10) and elastic band (12) are comprised of a biodegradable elastomer;

7. The herbicide application device of claim 1 wherein said applicator (10) and elastic band (12) are comprised of a synthetic elastomer;

8. The herbicide application device of claim 7 wherein said applicator (10) and elastic band (12) are comprised of a biodegradable elastomer;

9. The herbicide application device of claim 1 wherein said applicator (10) and elastic band (12) are impervious to the herbicide (21) and water so that neither the herbicide (21) nor water may permeate the elastomer;

10. A method of targeting and eliminating an unwanted plant without exposing surrounding vegetation or human user to herbicide comprising the steps of:
cutting or pruning the unwanted plant above grade such that the plant wound is exposed;
stretching an elastic, generally tubular device with a first open end and a second closed end such that the cross-sectional diameter of the first open end is larger than the cross-sectional diameter of the plant stem;
positioning the tubular device over the plant stem such that they roughly share the same longitudinal axis;
stretching or rolling the tubular device longitudinally along the axis of the plant stem such that the tubular device encapsulates the plant stem and seals itself against the plant stem, thereby enabling a pre-loaded herbicide within the tubular to device to remain in constant contact with the plant stem such that the herbicide may penetrate the plant stem at its cut wound;
